(19) United States
(12) Patent Application Publication
(10) Pub. No.: US 2026/0014892 A1
(43) Pub. Date: Jan. 15, 2026

(54) CHARGING OPTIMIZATION METHODS AND SYSTEMS FOR NEW ENERGY VEHICLES

(71) Applicant: XCHARGE ENERGY USA INC., Kyle, TX (US)

(72) Inventors: Junshuai WANG, Kyle, TX (US); Rui DING, Kyle, TX (US)

(73) Assignee: XCHARGE ENERGY USA INC., Kyle, TX (US)

(21) Appl. No.: 18/773,512

(22) Filed: Jul. 15, 2024

(51) Int. Cl. B60L 53/64; B60L 53/62

(52) U.S. Cl. CPC B60L 53/64; B60L 53/62; B60L 2260/50

(57) ABSTRACT

Disclosed is a charging optimization method and system for a new energy vehicle. The system comprises: an acquisition module, an interaction module, a first processing module, a second processing module, a control module, and a storage module. The acquisition module is configured to obtain data. The first processing module is configured to determine candidate parameters. The interaction module is configured to send the candidate parameters to a user and obtain a target charging parameter. The second processing module is configured to determine an optimized charging parameter. The control module is configured to generate an optimized charging instruction and send the optimized charging instruction to a battery management system for battery charging; in response to completing charging, generate current charging information and a storage update instruction; and send a reminder. The storage module is configured to store the current charging information and storage information; and delete historical charging information.

### TECHNICAL FIELD

The present disclosure relates to the field of charging of new energy vehicles, and in particular to a charging optimization method and system for a new energy vehicle.

### BACKGROUND

A charging cost during a charging process of new energy vehicles (e.g., electric vehicles) includes not only a cost of electricity, but also often involves an aging depreciation cost of batteries, a cost of charging time, or the like, that may be caused by different charging parameters. Meanwhile, users have different power requirements for the electric vehicles in different usage scenarios. How to better meet the charging requirements of the users is an urgent issue.

Therefore, it is desirable to provide a charging optimization method and system for a new energy vehicle to optimize charging planning of electric vehicles, improve the charging efficiency, and save the charging cost.

### SUMMARY

One or more embodiments of the present disclosure provide a charging optimization system for a new energy vehicle. The charging optimization system may comprise an acquisition module, an interaction module, a first processing module, a second processing module, a control module, and a storage module. The acquisition module may be configured to obtain a user charging requirement, charging price information, and a battery load feature. The first processing module may be configured to determine, based on the user charging requirement and the charging price information, one or more candidate parameters. The one or more candidate parameters may include a candidate charging parameter and an estimated charging cost of the candidate charging parameter. The interaction module may be configured to send the one or more candidate parameters to a user and obtain a target charging parameter returned by the user. The second processing module may be configured to determine, based on the battery load feature and the target charging parameter, an optimized charging parameter. The optimized charging parameter may include at least one of charging voltages, charging currents, and charging durations in a plurality of phases. The control module may be configured to: generate, based on the optimized charging parameter, an optimized charging instruction and send the optimized charging instruction to a battery management system to cause the battery management system to charge a battery based on the optimized charging instruction; in response to determining that the battery management system completes charging, generate current charging information and a storage update instruction and send the current charging information and a storage update instruction and send the current charging information and the storage update instruction to the storage module; and control the interaction module to send a reminder to the user. The storage module may store historical charging information and storage information of the historical charging information. The storage information may include a count of calls for the historical charging information and a storage duration. The storage module may be configured to: store, based on the storage update instruction, the current charging information and the storage information of the current charging information; and delete the historical charging information of which the storage information satisfies a preset deletion condition. The preset deletion condition may include that the storage duration is greater than a second preset value, and a count of calls within a preset period for the historical charging information is less than a first preset value.

One or more embodiments of the present disclosure provide a charging optimization method for a new energy vehicle, implemented based on a charging optimization system for a new energy vehicle. The charging optimization method may comprise: obtaining a user charging requirement, charging price information, and a battery load feature; determining, based on the user charging requirement and the charging price information, one or more candidate parameters, the one or more candidate parameters including a candidate charging parameter and an estimated charging cost for the candidate charging parameter; sending the one or more candidate parameters to a user and obtaining a target charging parameter returned by the user; determining, based on the battery load feature and the target charging parameter, an optimized charging parameter, the optimized charging parameter including at least one of charging voltages, charging currents, and charging durations in a plurality phases; generating, based on the optimized charging parameter, an optimized charging instruction and sending the optimized charging instruction to a battery management system to cause the battery management system to charge a battery based on the optimized charging instruction; in response to determining that the battery management system completes charging, generating current charging information, and storing the current charging information as the historical charging information, and storing the current charging information as storage information, the storage information including a count of calls for the historical charging information and a storage duration; sending a reminder to the user; and deleting historical charging information of which the storage information satisfies a preset deletion, the preset deletion condition including that the storage duration is greater than a second preset value and a count of calls within a preset period for the historical charging information is less than a first preset value.

One or more embodiments of the present disclosure provide a non-transitory computer-readable storage medium comprising computer instructions that, when read by a computer, may direct the computer to implement the charging optimization method for the new energy vehicle.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an exemplary charging optimization system for a new energy vehicle according to some embodiments of the present disclosure;

FIG. 2 is a flowchart illustrating an exemplary charging optimization method for a new energy vehicle according to some embodiments of the present disclosure;

FIG. 3 is a flowchart illustrating an exemplary process for determining one or more candidate parameters according to some embodiments of the present disclosure;

FIG. 4 is a schematic diagram illustrating an exemplary process for determining a user charging requirement according to some embodiments of the present disclosure; and

FIG. 5 is a schematic diagram illustrating an exemplary first prediction model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person having ordinary skills in the art to apply the present disclosure to other similar scenarios in accordance with these drawings without creative labor. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, portions or assemblies of different levels. However, the words may be replaced by other expressions if other words can achieve the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

Charging requirements and charging costs of electric vehicles are constantly changing in different usage scenarios. Accordingly, determining preferred charging plans before charging the electric vehicles can effectively save costs and improve charging efficiency.

In view of the above, in some embodiments of the present disclosure, it is desirable to provide a charging optimization method and system for a new energy vehicle, to consider actual charging requirements of electric vehicles in different scenarios and determine charging parameters in combination with the step tariff of the power grid and battery features to determine preferred charging plans, thereby helping charging users reduce costs, and better meeting the charging requirements of users.

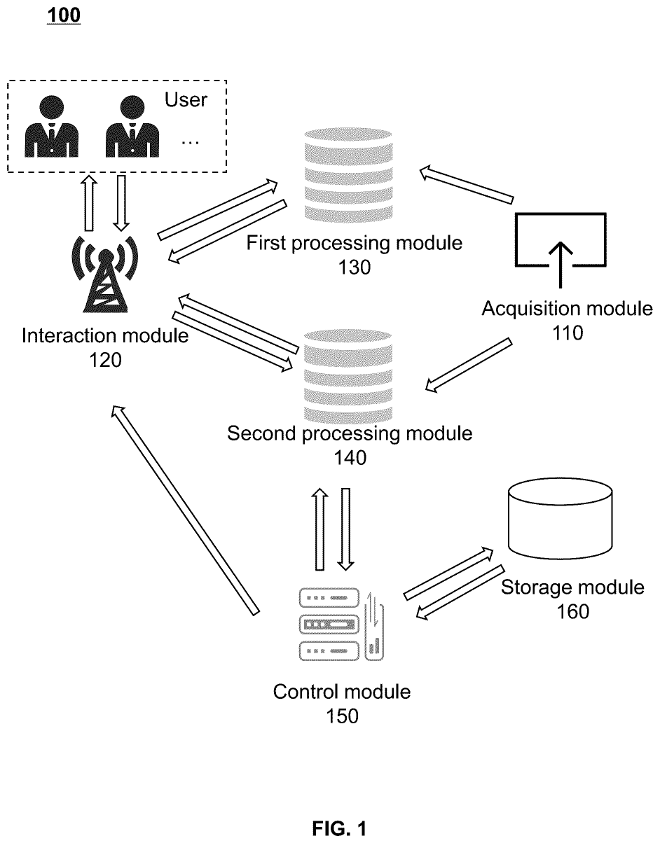

FIG. 1 is a schematic diagram illustrating an exemplary charging optimization system for a new energy vehicle according to some embodiments of the present disclosure.

In some embodiments, a charging optimization system 100 for a new energy vehicle may include an acquisition module 110, an interaction module 120, a first processing module 130, a second processing module 140, a control module 150, and a storage module 160.

The acquisition module 110 refers to a module for acquiring relevant data. In some embodiments, the acquisition module 110 may be configured to obtain a user charging requirement, charging price information, and a battery load feature.

In some embodiments, the acquisition module 110 may be further configured to: call target historical information and obtain current time information and current position information of a vehicle to be charged. The target historical information refers to historical charging information of which a storage duration does not exceed a preset duration.

In some embodiments, the acquisition module 110 may be further configured to: obtain navigation information, a current power level, and historical trip information of the vehicle to be charged.

In some embodiments, the acquisition module 110 may interact with the first processing module 130 and the second processing module 140. For example, the acquisition module may send the acquired user charging requirement to the first processing module 130, and send the acquired battery load feature to the second processing module 140.

The interaction module 120 refers to a module for the system 100 to interact with a user. In some embodiments, the interaction module 120 may be configured to send one or more candidate parameters to the user and obtain a target charging parameter returned by the user.

In some embodiments, the interaction module 120 may interact with the first processing module 130 and the second processing module 140. For example, the interaction module may obtain the target charging parameter from the user and send the target charging parameter to the second processing module 140.

The first processing module 130 refers to a module for processing data and/or information. In some embodiments, the first processing module 130 may be configured to determine, based on the user charging requirement and the charging price information, the one or more candidate parameters. The one or more candidate parameters may include a candidate charging parameter and an estimated charging cost for the candidate charging parameter.

In some embodiments, the first processing module 130 may be further configured to: determine, based on the target historical information, a user charging habit; determine, based on the user charging habit, the current time information, and the current position information, an available charging duration; and determine, based on the available charging duration, the charging price information, and the user charging requirement, the one or more candidate parameters.

In some embodiments, the first processing module 130 may be further configured to: determine, based on the current position information, a current charging scenario; and determine, based on the user charging habit, the current time information, and the current charging scenario, the available charging duration.

In some embodiments, the first processing module 130 may be further configured to: determine, based on the navigation information, the current charging scenario, the target historical information, and the historical trip information, a length of a next trip; and determine, based on the length of the next trip and the current power level, the user charging requirement.

In some embodiments, the first processing module 130 may be further configured to: determine, based on the navigation information, the current charging scenario, the target historical information, and the historical trip information, lengths of one or more next trips and a confidence level corresponding to a length of each of the one or more next trips through a first prediction model. The first prediction model may be a machine learning model.

In some embodiments, the first processing module 130 may be further configured to: determine, based on a weighted value of the lengths of the one or more next trips and the current power level, the user charging requirement. The weighted value of the lengths of the one or more next trips may be related to the confidence level corresponding to the length of each of the one or more next trips.

In some embodiments, the first processing module 130 may interact with the interaction module 120. For example, the first processing module 130 may send the one or more candidate parameters to the interaction module 120.

The second processing module 140 refers to a module for processing data and/or information. In some embodiments, the second processing module 140 may be configured to determine, based on the battery load feature and the target charging parameter, the optimized charging parameter. The optimized charging parameter may include at least one of charging voltages, charging currents, and charging durations in a plurality of phases.

In some embodiments, the second processing module 140 may be further configured to: determine, based on the battery load feature and the target charging parameter, a plurality of candidate optimization parameters; and determine, based on the plurality of candidate optimization parameters, the optimized charging parameter.

In some embodiments, the second processing module 140 may be further configured to: determine, based on a second prediction model, an evaluation parameter of each of the plurality of candidate optimization parameters, the evaluation parameter including a charging loss and a charging gain; and determine, based on the evaluation parameter of each of the plurality of candidate optimization parameters, the optimized charging parameter.

In some embodiments, the second processing module 140 may interact with modules such as the interaction module 120, the control module 150, the acquisition module 110, or the like. For example, the second processing module 140 may send the optimized charging parameters to the control module 150.

The control module 150 refers to a module for exercising control over computer instructions. In some embodiments, the control module 150 may be configured to: generate, based on the optimized charging parameter, an optimized charging instruction and send the optimized charging instruction to a battery management system to cause the battery management system to charge a battery based on the optimized charging instruction; in response to determining that the battery management system completes charging, generate current charging information and a storage update instruction and send the current charging information and the storage update instruction to the storage module; and control the interaction module to send a reminder to the user.

In some embodiments, the control module 150 may interact with various modules (e.g., the second processing module 140, the interaction module 120, the storage module 160, etc.) of the charging optimization system 100 for the new energy vehicle. For example, the control module 150 may control the interaction module 120 to send the reminder to the user.

The storage module 160 refers to a module for storing data, instructions, and/or any other information. In some embodiments, the storage module 160 may store historical charging information and storage information of the historical charging information. The storage information may include a count of calls for the historical charging information and a storage duration.

In some embodiments, the storage module may be configured to store, based on the storage update instruction, the current charging information and the storage information of the current charging information; and delete historical charging information of which the storage information satisfies a preset deletion condition. The preset deletion condition may include that the storage duration is greater than a second preset value, and a count of calls within a preset period for the historical charging information is less than a first preset value.

In some embodiments, the storage module 160 may be further configured to: update the count of calls for the target historical information.

In some embodiments, the storage module 160 may interact with the control module 150. For example, the storage module 160 may obtain the storage update instruction from the control module 150.

In some embodiments, the storage module 160 may include one or more storage components. Each of the one or more storage components may be a stand-alone device or may be a portion of other devices. In some embodiments, the storage device 160 may include a random access memory (RAM), a read-only memory (ROM), or the like, or any combination thereof. In some embodiments, the storage device 160 may be implemented on a cloud platform.

In some embodiments, at least one module (e.g., the acquisition module 110, the interaction module 120, the first processing module 130, the second processing module 140, the control module 150, and the storage module 160) of the charging optimization system 100 for the new energy vehicle may exchange information and/or data with at least one other module of the charging optimization system 100 for the new energy vehicle via a network. For example, the control module 150 may retrieve information and/or data from the storage module 160. The network (not shown in the figures) may include any suitable network capable of facilitating the exchange of information and/or data.

In some embodiments, the user may perform data and/or information interaction with the charging optimization system 100 for the new energy vehicle through the interaction module 120 via a terminal device. The user may be a user of the charging optimization system 100 for the new energy vehicle. The terminal device may include, but is not limited to, a mobile phone, a tablet computer, or the like.

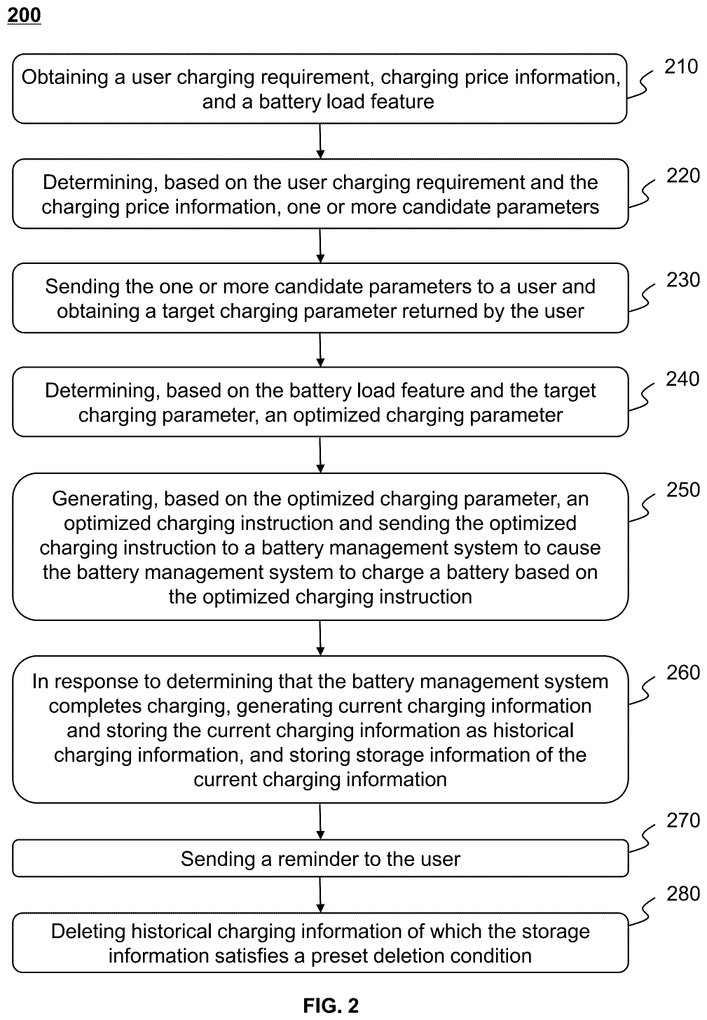

More descriptions regarding the functions associated with the above modules may be found in FIGS. 2-5 and related descriptions thereof.

Reasonable and efficient charging plans can be formulated for the user autonomously and intelligently through the coordinated operation of the various modules of the charging optimization system 100 for the new energy vehicle, thereby reducing the waste of unnecessary charging costs.

It should be noted that the above description of the charging optimization system for a new energy vehicle and the modules thereof is only for descriptive convenience, and does not limit the present disclosure to the scope of the cited embodiments. It is understood that for a person skilled in the art, after understanding the principle of the system, it may be possible to arbitrarily combine individual modules or form a subsystem to connect with other modules without departing from this principle. In some embodiments, the acquisition module 110, the interaction module 120, the first processing module 130, the second processing module 140, the control module 150, and the storage module 160 disclosed in FIG. 1 may be different modules in a single system, or a single module may implement the functions of two or more of the modules. For example, the individual modules may share a common storage module, and the individual modules may each have their own storage module. Such variations are within the scope of protection of the present disclosure.

FIG. 2 is a flowchart illustrating an exemplary charging optimization method for a new energy vehicle according to some embodiments of the present disclosure. As shown in FIG. 2, a process 200 may include the following operations. In some embodiments, the process 200 may be performed by the charging optimization system 100 for the new energy vehicle.

In 210, a user charging requirement, charging price information, and a battery load feature may be obtained. In some embodiments, the operation 210 may be performed by the acquisition module 110.

The user charging requirement refers to a charging level required for current charging. In some embodiments, the user charging requirement may be obtained in various ways. For example, the user charging requirement may be determined by obtaining information inputted by a user based on the interaction module 120.

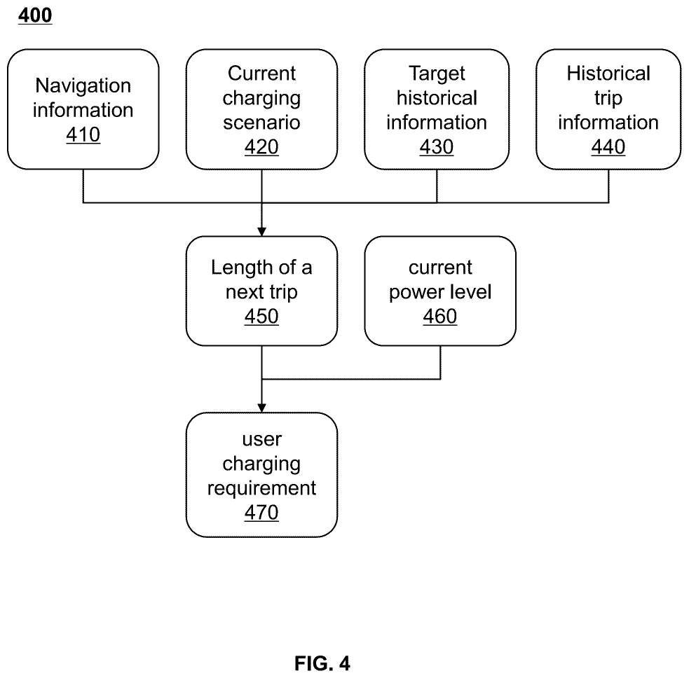

In some embodiments, the user charging requirement may be predicted through the first processing module 130. More descriptions about predicting the user charging requirement through the first processing module 130 may be found in FIG. 4 and related descriptions thereof.

The charging price information refers to information related to electricity price or a billing mode, etc., during each charging period. Charging price of a charging pile during a current period may be determined based on the charging price information.

In some embodiments, the charging pile may include one or more different billing modes, such as a step tariff and/or a time-of-use (TOU) tariff. The TOU tariff refer to that 24 hours of a day are divided into time periods, and different time periods correspond to different electricity prices. The step tariff refers to that electricity consumptions during charging correspond to different electricity prices, i.e., the more the electricity consumption, the higher the electricity price.

In some embodiments, the charging price information may be obtained by querying via a network through the acquisition module 110.

The battery load feature refers to feature data related to a battery load. In some embodiments, the battery load feature may include an overall voltage, a capacity, and a state of charge (SOC) of a battery pack; a voltage, a capacity, and an SOC of an individual battery module; and a voltage, a capacity, and an SOC of an individual battery cell. The battery pack may include one or more battery modules. The one or more battery modules may include one or more battery cells.

In some embodiments, the battery load feature may be obtained from a battery management system through the acquisition module 110.

In 220, one or more candidate parameters may be determined based on the user charging requirement and the charging price information. In some embodiments, the operation 220 may be performed by the first processing module 130.

The one or more candidate parameters refer to parameters of a charging process. For example, the one or more candidate parameters may include a charging start time, a charging end time, a charging duration, a charging mode, an estimated charging level, or the like.

In some embodiments, the one or more candidate parameters may include a candidate charging parameter and an estimated charging cost for the candidate charging parameter.

The candidate charging parameter refers to a candidate parameter related to the charging process, such as the charging duration, the charging start time, or the like. The estimated charging cost refers to an estimated economic cost corresponding to the candidate charging parameter, facilitating the user to select an appropriate candidate charging parameter.

In some embodiments, the one or more candidate parameters may be determined in various ways. For example, the first processing module 130 may automatically generate a plurality of charging modes and a plurality of candidate charging parameters corresponding to the plurality of charging modes, and determine a corresponding estimated charging cost based on a specific candidate charging parameter.

For example, the first processing module 130 may generate the plurality of charging modes. Considering that a fast charging mode and a slow charging mode require manual interface switching, in order to reduce the workload of manual operation, the plurality of charging modes in the present embodiment may include [fast charging mode], [slow charging mode], [fast charging+slow charging mode], [slow charging+fast charging mode], etc. The first processing module 130 may preset candidate charging parameters and estimated charging costs corresponding to the candidate charging parameters based on the four charging modes.

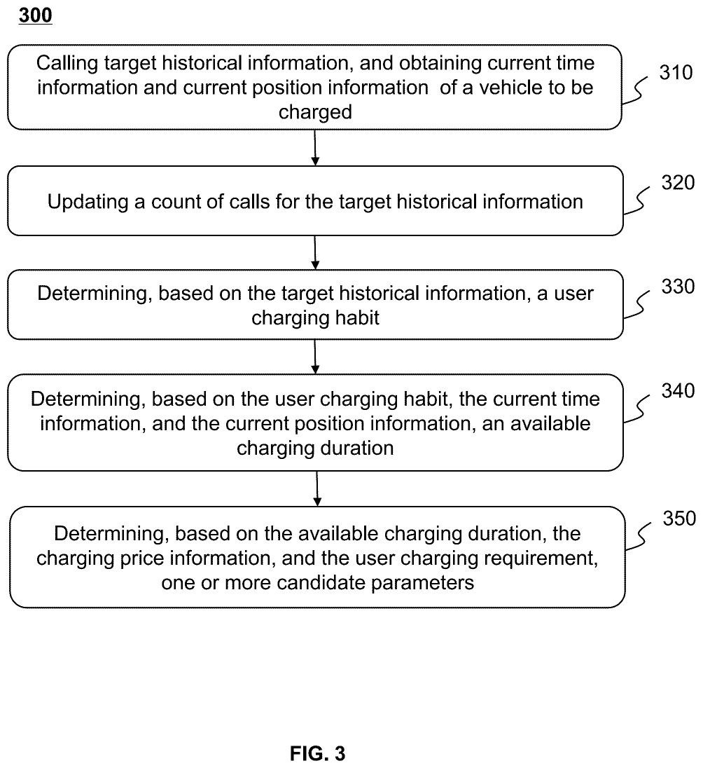

In some embodiments, the one or more candidate parameters may also be determined based on an available charging duration, the charging price information, and the user charging requirement. More descriptions regarding determining the one or more candidate parameters based on the available charging duration, the charging price information, and the user charging requirement may be found in FIG. 3 and related descriptions thereof.

In 230, the one or more candidate parameters may be sent to a user and a target charging parameter returned by the user may be obtained. In some embodiments, the operation 230 may be performed by the interaction module 120.

The target charging parameter refers to a charging parameter confirmed by the user after modification. In some embodiments, the target charging parameters may include the charging duration, the charging mode, the estimated charging level, etc. The charging duration refers to a duration of the charging process. The charging mode refers to a manner of charging, which may include the fast charging mode, the slow charging mode, or any combination thereof. The estimated charging level refers to an estimated charging level for a vehicle to be charged.

The vehicle to be charged refers to an electric vehicle that is driven into or parked near a charging facility (e.g., a charging pile and a charging station) but does not start charging or is waiting to be charged. The electric vehicle may include an electric vehicle (EV), a plug-in hybrid electric vehicle (PHEV), etc.

In some embodiments, the user may modify or confirm the one or more candidate parameters based on the interaction module 120. For example, the user may modify the charging duration in one of the one or more candidate parameters, and the first processing module 130 may automatically generate the corresponding estimated charging cost based on the candidate charging parameter modified by the user. The user may send the confirmed candidate charging parameter and the estimated charging cost as the target charging parameter to the second processing module 140 based on the interaction module 120.

In 240, an optimized charging parameter may be determined based on the battery load feature and the target charging parameter. In some embodiments, the operation 240 may be performed by the second processing module 140.

The optimized charging parameter refers to a charging parameter that is ultimately sent to the battery management system for execution. In some embodiments, the battery management system may adaptively adjust the optimized charging parameter based on the SOC.

In some embodiments, the optimized charging parameter may include at least one of charging voltages, charging currents, and charging durations in a plurality of phases.

The plurality of phases refer to different phases of the battery during the charging process. For example, the battery may include a pre-charging phase, a normal charging phase, etc., during the charging process. In addition, if the battery is full and there is still charging time remaining, an equalized charging phase or a float charging phase may also be included.

The pre-charging phase refers to a charging phase used to determine whether an outer voltage of a direct current (DC) relay is normal before formal charging, which may be used to alleviate the impact of a high voltage system and improve the charging safety of the whole vehicle. The normal charging phase refers to a phase in which the vehicle is charged using the fast charging mode or the slow charging mode. Equalized charging, also referred to as balanced charging, refers to charging to compensate for an uneven voltage generated by the battery during use to bring the voltage back into a prescribed range, or to wave energy recharging after high capacity discharging. Float charging refers to that a charging device bears a regular load during a normal operation, while supplementing the battery pack with additional charging to compensate for self-discharging of battery, keeping the battery at full capacity in standby.

Only one of the equalized charging phase or the float charging phase can be on at the same time.

In some embodiments, the optimized charging parameter may be obtained in various ways. For example, the optimized charging parameter may be obtained by querying a vector database.

In some embodiments, the second processing module 140 may construct a load feature vector based on a battery pack voltage, a battery pack capacity, a battery pack SOC, a battery module mean voltage, a battery module mean capacity, a battery module mean SOC, a battery cell mean voltage, a battery cell voltage variance, a battery cell voltage range, a battery cell mean capacity, a battery cell mean SOC, a battery cell SOC variance, and a battery cell SOC range; and construct a parameter feature vector based on the charging duration, the charging mode, and the estimated charging level in the target charging parameter. A feature vector to be matched may be obtained based on synthesizing the load feature vector and the parameter feature vector. For example, the feature vector to be matched may be a spliced vector of the load feature vector and the parameter feature vector.

The second processing module 140 may determine a target vector database based on the charging mode in the target charging parameter, and then use a reference vector of which a vector distance from the feature vector to be matched is minimum or the vector distance from the feature vector to be matched is less than a preset distance threshold as a target vector based on a match result of the feature vector to be matched with one or more reference vectors in the target vector database. A reference optimized charging parameter corresponding to the target vector may be used as the optimized charging parameter corresponding to the feature vector to be matched.

The one or more reference vectors may be constructed based on historical battery load features and historical target charging parameters of historical charging in the same manner as the feature vector to be matched. The second processing module 140 may use a charging parameter that meets a speed requirement of the charging mode when the historical charging is completed, and the battery cell SOC variance is minimum when the charging is completed (i.e., when the battery cell SOC is most balanced after the charging is completed) as the reference optimized charging parameter corresponding to the reference vector. Different charging modes may correspond to different vector databases. For example, the four charging modes may correspond to four different vector databases. The corresponding target vector database may be determined based on the charging mode of the feature vector to be matched.

In some embodiments, the second processing module 140 may be further configured to: determine a plurality of candidate optimization parameters based on the battery load feature and the target charging parameter; and determine the optimized charging parameter based on the plurality of candidate optimization parameters.

The plurality of candidate optimization parameters refer to alternative optimized charging parameters. In some embodiments, the plurality of candidate optimization parameters may be randomly generated within a candidate optimization parameter range.

The candidate optimization parameter range refers to a value range of candidate optimization parameters. In some embodiments, the candidate optimization parameter range may be obtained by querying the vector database. Merely by way of example, as the same manner as the determination of the optimized charging parameter, the feature vector to be matched may be constructed based on the battery load feature and the target charging parameter, the target vector may be matched in the target vector database, and an optimization parameter range corresponding to the target vector may be used as the candidate optimization parameter range. That is, when the vector database is constructed, the optimization parameter range corresponding to each of the one or more reference vectors may be determined based on historical charging data.

In some embodiments, the second processing module 140 may determine the optimized charging parameter in various ways. For example, the second processing module 140 may calculate a charging cost required for each of a plurality of candidate optimized charging parameters, and use a candidate optimized charging parameter of the plurality of candidate optimized charging parameters with the lowest charging cost as the optimized charging parameter.

In some embodiments, the second processing module 140 may be further configured to: determine an evaluation parameter of each of the plurality of candidate optimization parameters based on a second prediction model; and determine the optimized charging parameter based on the evaluation parameter of each of the plurality of candidate optimization parameters.

The evaluation parameter refers to an indicator used to characterize the quality of each of the plurality of candidate optimization parameters. In some embodiments, the evaluation parameter may include a charging loss and a charging gain.

The charging loss refers to a loss brought to the battery during a fast charging process or a slow charging process. The charging gain refers to a gain brought to the battery by equalized or floating charging.

The second prediction model refers to a model for evaluating an extent to which the plurality of candidate optimization parameters contribute to the loss and/or gain of the charging process. In some embodiments, the second prediction model may be a machine learning model, such as any one or combination of deep neural networks (DNN), convolutional neural networks (CNN), or the like.

In some embodiments, an input of the second prediction model may include the plurality of candidate optimization parameters and the battery load feature, and an output of the second prediction model may include the evaluation parameter (e.g., the charging loss and the charging gain).

In some embodiments, the second prediction model may be obtained by training based on a large number of first training samples with first labels. A loss function may be constructed based on the first labels and prediction results of an initial second prediction model. The initial second prediction model may be iteratively updated based on the loss function. The training process may be completed when the loss function of the initial second prediction model satisfies a preset condition. The preset condition may be that the loss function converges, or a count of iteration reaches a threshold, etc.

In some embodiments, the first training samples may include a sample charging parameter used in historical charging of a sample battery, and a battery load feature of the sample battery. The first training samples may be obtained based on historical data. The first labels may include a charging loss and a charging gain of the sample battery after charging is completed under the first training samples.

In some embodiments, when the sample battery completes the pre-charging phase and the normal charging phase under the first training samples, a decay value of a state of health (SOH) of the sample battery may be used as the charging loss. When the sample battery completes the float charging phase or the equalized charging phase under the first training samples, a decay value of a battery cell SOC variance may be used as the charging gain. The SOH and the decay value of the battery cell SOC variance may be obtained based on the battery management system.

In some embodiments, the second processing module 140 may perform maximum-minimum normalization for the charging loss and the charging gain, respectively. That is, the charging losses corresponding to the plurality of candidate optimization parameters may be normalized as a first sequence of numbers. The charging gains corresponding to the plurality of candidate optimization parameters may be normalized as a second sequence of numbers. Normalization is a manner of converting data features to the same scale (i.e., a value range), such as mapping the data features to an interval [0, 1] or [−1, 1], or mapping the data features to a distribution obeying a mean of 0 and a variance of 1. In addition, a charging score may be determined for each of the plurality of candidate optimization parameters based on a normalized charging loss and a normalized charging gain, and a candidate optimization parameter of the plurality of candidate optimization parameters with the highest charging score may be taken as the optimized charging parameter.

The charging score refers to a quantitative characterization value of the charging gain and the charging loss. In some embodiments, the charging score may be calculated by weighting the charging gain and the charging loss. Merely by way of example, the charging score may be calculated by the following first algorithm:

$$s = {k}_{1} * g - {k}_{2} * l \qquad ( 1 )$$

wherein, s denotes the charging score, k₁ and k₂ denote a charging gain coefficient and a charging loss coefficient, respectively, g denotes the charging gain, and l denotes the charging loss. In some embodiments, both k₁ and k₂ may be positive numbers and may be preset.

The optimized charging parameter may be determined based on the evaluation parameters of each of the plurality of candidate optimization parameters through the second prediction model, so that the accuracy of determining the optimized parameter can be improved, and the data processing efficiency can be enhanced through model processing, thereby ensuring high efficiency of the charging process.

The optimized charging parameter may be determined from the plurality of candidate optimization parameters, so that preferred data can be efficiently selected from a large number of data, thereby ensuring data accuracy, and better adapting to the current charging requirement.

In 250, an optimized charging instruction may be generated based on the optimized charging parameter, and the optimized charging instruction may be sent to a battery management system to cause the battery management system to charge a battery based on the optimized charging instruction. In some embodiments, the operation 250 may be performed by the control module 150.

The optimized charging instruction refers to an instruction for controlling a charging component to charge the battery.

In some embodiments, the control module 150 may automatically generate the optimized charging instruction based on the optimized charging parameter.

In 260, in response to determining that the battery management system completes charging, current charging information may be generated and the current charging information may be stored as historical charging information, and storage information of the current charging information may be stored. In some embodiments, the operation 260 may be performed by the control module 150. For example, the control module 150 may control the storage module 160 to store the current charging information as the historical charging information, and store the storage information of the current charging information.

The charging information refers to a collection of information related to the charging process. For example, the current charging information may include charging time, a charging duration, a charging level, a charging position, and the optimized charging parameter used for current charging.

The storage information refers to a collection of data information of the historical charging information that needs to be stored. In some embodiments, the storage information may include a count of calls for the historical charging information and a storage duration. The count of calls refers to a count of times the acquisition module 110 retrieves the historical charging information from the storage module 160. More descriptions regarding the retrieving the historical charging information by the acquisition module 110 from the storage module 160 may be found in FIG. 3 and related descriptions thereof. The storage duration refers to a duration from the time when the historical charging information starts to be stored in the storage module 160 to the current time.

In 270, a reminder may be sent to the user. In certain embodiments, the operation 270 may be performed by the control module 150 by controlling the interaction module 120.

In some embodiments, after the charging is completed, the control module may control the interaction module to send the reminder to the user. The reminder may be conveyed in various ways. For example, the reminder may be sent to a terminal device of the user via a pop-up window, a text message, or the like.

In 280, historical charging information of which the storage information satisfies a preset deletion condition may be deleted. In some embodiments, the operation 280 may be performed by the storage module 160.

The preset deletion condition refers to a condition used to measure whether the storage information needs to be deleted. In some embodiments, the preset deletion condition may include that the storage duration is greater than a second preset value and a count of calls within a preset period is less than a first preset value.

The preset period is a preset period of time. For example, the preset period may be a past week, a past month, or the like. In some embodiments, the preset period may be obtained based on experience.

In some embodiments, the first preset value and the second preset value may be related a generation frequency of charging information during a historical preset time period. The historical preset time period refers to a time period in history, such as a month. The generation frequency refers to a count of times charging information is generated within a unit time period. For example, the generation frequency may be that the charging information is generated for five times within a month.

In some embodiments, the higher the generation frequency, the higher the first preset value and the lower the second preset value. In some embodiments, the first preset value and the second preset value may be obtained based on experience or adjusted based on an actual situation.

By obtaining the user charging requirement, the charging price, and the feature related the battery, the corresponding charging parameter may be generated through model processing, user-defined modification, or the like, thereby ensuring that the user requirement is met and the reasonableness of the charging parameter is intelligently evaluated through the model, and ensuring high efficiency during the charging process. Deleting redundant data that is too old or of low value can further release the memory, ensuring the operation speed and efficiency of the system.

FIG. 3 is a flowchart illustrating an exemplary process for determining one or more candidate parameters according to some embodiments of the present disclosure. As shown in FIG. 3, a process 300 may include the following operations. In some embodiments, the process 300 may be performed by the charging optimization system 100 for the new energy vehicle.

In 310, target historical information may be called, and current time information and current position information of a vehicle to be charged may be obtained. In some embodiments, the operation 310 may be performed by the acquisition module 110.

The target historical information refers to historical charging information of which a storage duration does not exceed a preset duration. In some embodiments, the preset duration is greater than an average interval of two charging sessions and may be preset based on experience. The average interval refers to a mean time of two charging intervals of the vehicle to be charged. More descriptions regarding the charging information and the storage duration may be found in FIG. 2 and related descriptions thereof.

The vehicle to be charged refers to an electric vehicle waiting for charging.

The historical charging information refers to all charging information stored in a storage module.

The current time information refers to information related to current time. For example, the current time information may include a current time point (e.g., 16:00), the day of the week (e.g., Saturday), or the like.

The current position information refers to a present position of the vehicle to be charged. In some embodiments, the current position information may be represented by latitude and longitude coordinates.

In 320, a count of calls for the target historical information may be updated. In some embodiments, the operation 320 may be performed by the storage module 160.

In some embodiments, each time the acquisition module 110 calls the historical charging information from the storage module 160, the count of calls for the historical charging information may be increased by 1. The count of calls for the historical charging information may be may be maintained based on the storage module 160.

In 330, a user charging habit may be determined based on the target historical information.

In some embodiments, the operation 330 may be performed by the first processing module 130.

The user charging habit refers to a user's habit of charging the vehicle. For example, the user charging habit may include that a user usually charges the vehicle on Saturdays, or the user usually charges the vehicle from 13:00-14:00, or the like.

In some embodiments, the user charging habit may be obtained through clustering. A vector may be constructed based on the target historical information (e.g., a chagrining start time, a charging end time, a charging level, charging position coordinates, and a charging duration), and then clustered to obtain a plurality of clusters. A central vector of each of the plurality of clusters may be obtained and used as the user charging habit.

In 340, an available charging duration may be determined based on the user charging habit, the current time information, and the current position information. In some embodiments, the operation 340 may be performed by the first processing module 130.

The available charging duration refers to a current duration used for charging.

In some embodiments, the available charging duration may be determined in various ways. For example, the available charging duration may be determined by querying a preset table. The preset table may be constructed based on the user charging habit. The preset table may include a correspondence between the charging start time, the charging position coordinates, and the charging duration.

In some embodiments, the first processing module 130 may select, from the preset table, a charging duration corresponding to a set of data in which coordinates of the charging start time and the charging position have the highest similarity to the current time information and the current position information as a current available charging duration.

In some embodiments, the first processing module 130 may be further configured to: determine, based on the current position information, a current charging scenario; and determine, based on the user charging habit, the current time information, and the current charging scenario, the available charging duration.

The current charging scenario refers to a scenario in which the vehicle to be charged is currently located. For example, the current charging scenario may include a shopping mall scenario, a community scenario, an office building scenario, a scenic spot scenario, a highway scenario, or the like.

In some embodiments, as for the current charging scenario, a corresponding location name may be obtained on a network map based on the current position information, and a scenario may be determined using a trained classifier based on the location name. The classifier may include a decision tree, a support vector machine, a neural network, or the like. Merely by way of example, if the location name corresponding to the current position information is a Wanda Plaza, the corresponding current charging scenario may be the shopping mall scenario.

In some embodiments, the first processing module 130 may convert the coordinates of the charging position in the user charging habit into historical charging scenarios in the same manner as described above, and a target historical charging scenario may be determined from the historical charging scenarios based on the current charging scenario obtained based on the current position information. The current charging scenario is the same as a scenario corresponding to the target historical charging scenario. The first processing module 130 may take an average value of the charging durations corresponding to all the obtained target historical charging scenarios, and use the average value as the current available charging duration.

In some embodiments, the first processing module 130 may also perform weighted summation based on the charging duration corresponding to the target historical charging scenario, and use a weighted sum of the charging duration corresponding to the target historical charging scenario as the current available charging duration. A weight of the charging duration corresponding to the target historical charging scenario for weighted summation may be positively related to a similarity of the charging start time of that target historical charging scenario to the current time information.

The available charging duration may be determined based on the current charging scenario, the user charging habit, and the current time information, so that the available charging duration that relatively satisfies the actual needs of the user can be determined even at a position where the user does not perform charging.

In 350, one or more candidate parameters may be determined based on the available charging duration, the charging price information, and the user charging requirement.

In some embodiments, the operation 350 may be performed by the first processing module 130. More descriptions regarding the charging price information, the user charging requirements, and the one or more candidate parameters may be found in FIG. 2 and related descriptions thereof.

In some embodiments, the first processing module 130 may calculate and determine the one or more candidate parameters based on the available charging duration, the charging price information, and the user charging requirement through a preset algorithm. The preset algorithm may include the following operations.

In 1, a fast charging duration satisfying the user charging requirement in a fast charging mode, and a slow charging duration satisfying the user charging requirement in a slow charging mode may be determined. That is, minimum and maximum durations required for sufficient charging level to satisfy the user charging requirement may be determined.

In 2: a relationship between a size of the available charging duration and a size of the fast charging duration and a relationship between the size of the available charging duration and a size of the slow charging duration may be determined.

In 21: in response to determining that the available charging duration is not greater than the fast charging duration, then charging may be performed directly in the fast charging mode and corresponding candidate charging parameters may be generated, and then a corresponding estimated charging cost may be determined based on the charging price information.

In 22: in response to determining that the fast charging duration is less than the available charging duration, operation 3 may be performed.

In 3: a charging price within the available charging duration may be determined. If there are multi-step tariffs, fast charging or slow charging may be performed within a time period with the lowest electricity price; if a charging level within the time period with the lowest electricity price does not meet a charging level required by the user, fast charging or slow charging may be performed within a time period with the second lowest electricity price, and so on, until the user charging requirement is met. Therefore, a plurality of candidate charging parameters and estimated charging costs corresponding to the plurality of candidate charging parameters may be generated.

In 31: in response to determining that the fast charging duration is less than the available charging duration and the available charging duration is less than the slow charging duration, the fast charging mode and the slow charging mode may be combined in use. Since fast charging and slow charging are not directly switched, and switching between fast charging and slow charging needs manually replacing charging sockets, the time periods corresponding to the fast and slow charging modes may be specified in the plurality of candidate charging parameters, making it easy for the user to know when to switch the charging sockets.

In 32: in response to determining that the slow charging duration is not greater than the available charging duration, charging may be performed using the slow charging mode alone, or using a combination of the fast charging mode and the slow charging mode.

In the operation 31 and the operation 32, when the charging time is sufficient and the battery is fully charged, float charging or equalized charging may continue to balance a battery state.

The charging modes and the one or more candidate parameters corresponding to the charging modes may be reasonably allocated based on the user charging requirement and the charging time, so that the charging efficiency can be effectively improved, battery loss can be reduced while meeting the user's needs as much as possible, and charging costs can be reduced, thereby enhancing the charging experience of the user.

It should be noted that the foregoing description of the process 300 is intended to be exemplary and illustrative only and does not limit the scope of application of the present disclosure. For a person skilled in the art, various corrections and changes may be made to the process 300 under the guidance of the present disclosure. However, these corrections and changes remain within the scope of the present disclosure.

FIG. 4 is a schematic diagram illustrating an exemplary process for determining a user charging requirement according to some embodiments of the present disclosure.

In some embodiments, an acquisition module may be further configured to obtain navigation information 410, a current charging scenario 420, and historical trip information 440 of a vehicle to be charged.

In some embodiments, a first processing module may be further configured to determine, based on the navigation information 410, the current charging scenario 420, target historical information 430, and the historical trip information 440, a length 450 of a next trip; and determine, based on the length 450 of the next trip and a current power level 460, a user charging requirement 470.

The navigation information refers to information related to a navigation process recorded by the vehicle to be recharged. For example, the navigation information may include at least one of current navigation information and previous navigation information. In some embodiments, the navigation information may further include a navigation start point, a planned end point, and an actual end point of each navigation. The planned end point refers to an expected end point position that the user inputs when the navigation is created. The actual end point refers to an end point position reached at an actual end of the navigation.

In some embodiments, the acquisition module may acquire the navigation information through a navigation system on the vehicle to be charged or a smartphone app connected to the vehicle to be charged.

The current power level refers to a current remaining battery capacity of the vehicle to be charged. For example, the current power level may be expressed as a percentage.

In some embodiments, the acquisition module may obtain the current power level of the vehicle to be charged through a battery management system.

The historical trip information refers to information related to all trips made by the vehicle to be charged during a historical preset time period. For example, the historical trip information may include, but is not limited to, trip time, a trip duration, trip start and end points, or the like. The historical preset time period may be set by a technician based on experience or set by the system based on the default.

In some embodiments, the acquisition module may obtain the historical trip information through an internal storage unit of the vehicle to be charged. The internal storage unit refers to a component for storing information such as log data, configuration information, or the like, of the vehicle to be charged. For example, the internal storage unit may be a flash memory, a solid-state disk, or the like.

More descriptions regarding the current charging scenario and the target historical information may be found in FIG. 3 and related descriptions thereof.

The length of the next trip refers to a length of a next trip predicted by the user.

In some embodiments, the first processing module may determine the length of the next trip in various ways. For example, in a scenario where a vehicle is traveling a long distance and stops for midway charging, the first processing module may determine a length of an uncompleted trip based on navigation information of the vehicle. In response to determining that the length of the uncompleted trip is not equal to 0, the length of the next trip may be equal to the length of the uncompleted trip. In response to determining that the length of the uncompleted trip equal to 0, the first processing module may determine the length of the next trip based on the current charging scenario, the target historical information, and the historical trip information.

The length of the uncompleted trip refers to a remaining distance of an uncompleted portion of a trip while the vehicle to be charged is traveling.

In some embodiments, the first processing module may determine the length of the uncompleted trip in various ways. In some embodiments, if navigation of the vehicle to be charged is not enabled at present (i.e., no current navigation information exists) and a previous navigation trip is completed, the length of the uncompleted trip may be equal to 0.

In some embodiments, if navigation of the vehicle to be charged is enabled at present, the length of the uncompleted trip may be equal to the remaining distance of the current navigated trip (i.e., a length of a distance between a current position of the vehicle to be charged and the planned end point).

In some embodiments, if navigation of the vehicle to be charged is not enabled at present, the previous navigation trip is ended in advance and the actual end point is the current position, the length of the uncompleted trip may be equal to a length of an uncompleted portion of the previous navigation trip (i.e., a length of a distance between the actual end point and the planned end point).

In some embodiments, in response to determining that the length of the uncompleted trip is equal to 0, the first processing module may determine the length of the next trip based on the current charging scenario, the target historical information, and the historical trip information.

In some embodiments, the first processing module may arrange the target historical information and the historical trip information in a chronological order; and determine target historical information of which a charging scenario is the same with that of the current charging scenario, and obtain a historical next trip corresponding to the target historical information; and then use an average value of lengths of a plurality of acquired historical next trips as the length of the next trip of the vehicle to be charged.

In some embodiments, the first processing module may be further configured to determine, based on the navigation information, the current charging scenario, the target historical information, and the historical trip information, lengths of one or more next trips and a confidence level corresponding to a length of each of the one or more next trips through a first prediction model.

In some embodiments, the first prediction model may be a machine learning model, such as any one or combination of deep neural networks (DNN), convolutional neural networks (CNN), or other custom model structures, etc.

In some embodiments, an input of the first prediction model may include the navigation information, the current charging scenario, the target historical information, and the historical trip information, and an output of the first prediction model may include the lengths of the one or more next trips and the confidence level corresponding to the length of each of the one or more next trips.

The confidence level corresponding to the length of each of the one or more next trips refers to an evaluation degree of the confidence level corresponding to a predicted length of each of the one or more next trips by the first prediction model. For example, the confidence level may be expressed as a value between 0 and 1. The closer the value is to 1, the higher the confidence level. More descriptions regarding the navigation information, the current charging scenario, the target historical information, the historical trip information, and the length of the next trip may be found in FIG. 4 and related descriptions thereof.

In some embodiments, the first prediction model may be obtained by training based on a large number of second training samples with second labels. A plurality of second training samples with the second labels may be input into an initial first prediction model. A loss function may be constructed based on the second labels and results of the initial first prediction model. Parameters of the initial first prediction model may be iteratively updated based on the loss function. The model training may be completed when the loss function of the initial first prediction model satisfies a preset condition, and a trained first prediction model may be obtained. The preset condition may be that the loss function converges, a count of iterations reaches a threshold, etc.

In some embodiments, the second training samples may include sample navigation information, a sample current charging scenario, sample target historical information, and sample historical trip information in historical data. The second labels may include actual lengths of one or more next trips actually determined subsequently corresponding to the second training samples and a confidence level corresponding to the actual length of each of the one or more next trips.

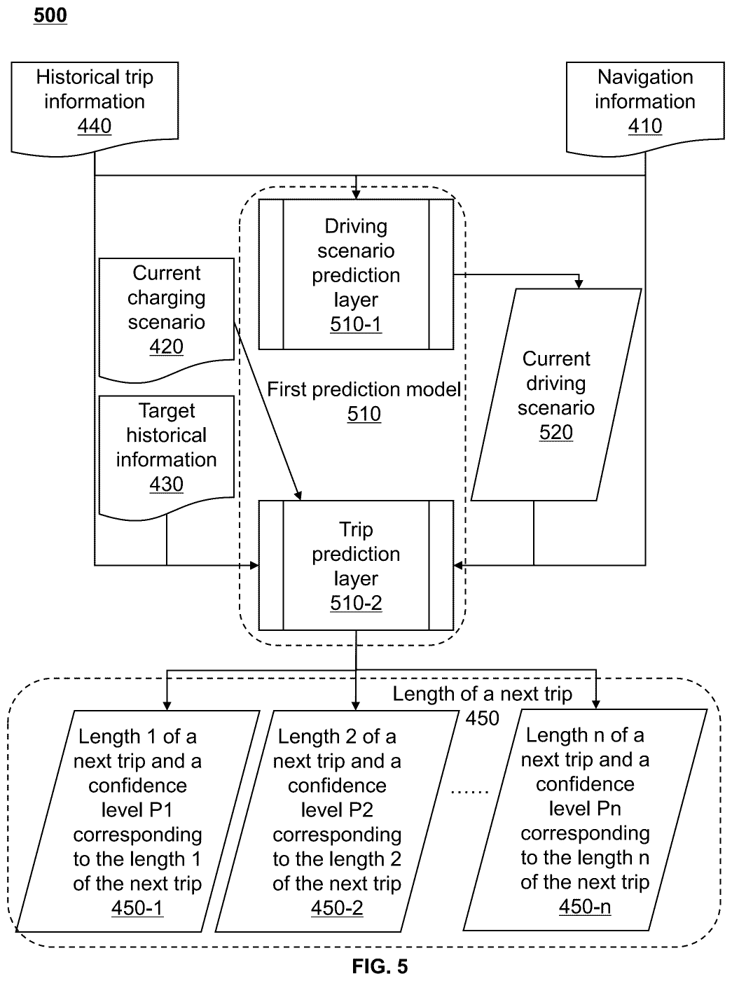

The second labels may include labels (hereinafter referred to as length labels) of the lengths of the one or more next trips corresponding to the second training samples and labels (hereinafter referred to as confidence level labels) of the confidence level corresponding to the length of each of the one or more next trips. In some embodiments, if label values of the length labels are equal to the actual lengths of the one or more next trips corresponding to the second training samples, label values of the confidence level labels corresponding to the length labels may be 1. If the label values of the length labels are not equal to the actual lengths of the one or more next trips corresponding to the second training samples, the label values of the confidence level labels corresponding to the length labels may be within a range of [0, 1). The specific values may be determined based on differences between the label values of the length labels and the actual lengths of the one or more next trips. The smaller the differences, the closer the label values of the confidence level labels are to 1. More descriptions regarding the first prediction model may be found in FIG. 5 and related descriptions thereof.

In some embodiments of the present disclosure, the first processing module may predict, based on the navigation information, the current charging scenario, target historical information, and the historical trip information, the length of the next trip through the first prediction model, and provide the confidence level for each prediction result, so as to better help the user plan the charging trips, improve the charging efficiency, and reduce waiting time for charging, thereby enhancing overall user experience.

The user charging requirement may include a minimum charging level to be achieved for current charging. More descriptions regarding the user charging requirement may be found in FIG. 1 and related descriptions thereof.

In some embodiments, the first processing module may determine the user charging requirement in various ways. For example, the first processing module may determine the user charging requirement through a second preset algorithm based on a relationship that the user charging requirement is positively related to the length of the next trip and negatively related to the current power level. The second preset algorithm may be represented as follows:

$$R = a \times B - P + Q \qquad ( 2 )$$

wherein R denotes the user charging requirement; a denotes the length of the next trip; B denotes a power level required per unit length of the trip; P denotes the current power level of the vehicle; and Q denotes minimum reserved power level.

In some embodiments, the length a of the next trip segment may be an average value of the lengths of a plurality of historical next trips. In some embodiments, the length a of the next trip may also be a length of the next strip corresponding to a maximum confidence level in the first prediction model.

In some embodiments, the power level B required per unit length of the trip may be determined through historical trip data. The minimum reserved power level Q may be a fixed value. For example, minimum reserved power level Q may be set at 20% of a battery capacity.

In some embodiments, the first processing module may be further configured to determine the user charging requirement based on a weighted value of the lengths of the one or more next trips and the current power level. The weighted value of the lengths of the one or more next trips may be related to the confidence level corresponding to the length of each of the one or more next trips.

In some embodiments, the first processing module may also determine the user charging requirement through a third preset algorithm based on a relationship that the user charging requirement is positively related to the weighted value of the lengths of the one or more next trips and negatively related to the current power level. The third preset algorithm may be represented as follows:

$$R = k 1 \times a 1 + k 2 \times a 2 + … + kn \times an - P + Q \qquad ( 3 )$$

wherein, the weighted value is denoted as k1×a1+k2×a2+ . . . +kn×an, an denotes a length of an nth next trip; and kn denotes a weight corresponding to the length of the nth next trip. In some embodiments, the weights of the lengths of the one or more next trips may be positively related to the confidence level corresponding to the length of each of the one or more next trips.

In some embodiments, the weighted value of the lengths of the one or more next trips may also be related to the available charging duration. For example, the first processing module may determine the weight of the length of each of the one or more next trips when the weighted value of the lengths of the one or more next trips is calculated based on the available charging duration.

In some embodiments, the first processing module may determine the weight of the length of each of the one or more next trips through a fourth preset algorithm based on a relationship that the weight of the length of each of the one or more next trips is positively related to the available charging duration. The fourth preset algorithm may be represented as follows:

$$kn = bn \times B \times \frac{T}{tn} \qquad ( 4 )$$

wherein tn denotes fast charging time for power required for a length of an nth next trip; and T denotes the available charging duration.

In some embodiments, the fast charging time tn for the power required for the length of the nth next trip may be determined through historical data. For example, the fast charging time tn for the power required for the length of the nth next trip may be an average value of fast charging times of power required for corresponding historical lengths of one or more next trips of the vehicle to be charged.

In some embodiments of the present disclosure, the first processing module may slightly adjust a weight of a length of a relatively long next trip based on the available charging duration, to more accurately reflect the actual charging requirement of the user. Such adjustment can improve the prediction accuracy of the charging requirement, which in turn improves the effect of the system in charging planning and optimization, thereby enhancing the user experience and charging efficiency.

In some embodiments of the present disclosure, the first processing module may comprehensively consider the confidence levels corresponding to different lengths of the one or more next trips and the current power level by considering the weighted value of the lengths of the one or more next trips and the current power level, so as to more accurately determine the user charging requirement.

In some embodiments of the present disclosure, the first processing module may more accurately predict the length of the next trip of the user based on the navigation information, the current charging scenario, the target historical information, and the historical trip information, which improves the accuracy and credibility of prediction. In addition, the charging time and the charging level may be reasonably arranged based on the length of the next trip of the user and the current power level, thereby better optimizing the charging plan, avoiding overcharging or undercharging, and improving the charging efficiency.

FIG. 5 is a schematic diagram illustrating a first model according to some embodiments of the present disclosure.

In some embodiments, a first prediction model 510 may further include a driving scenario prediction layer 510-1 and a trip prediction layer 510-2, as shown in FIG. 5. The driving scenario prediction layer 510-1 may be configured to determine a current driving scenario 520 based on the historical trip information 440 and the navigation information 410. The trip prediction layer 510-2 may be configured to determine lengths 450 of the one or more next trips and a confidence level corresponding to the length 450 (e.g., a length 1 of a next trip and a confidence level P1 corresponding to the length of the next trip 450-1, a length 2 of a next trip and a confidence level P2 corresponding to the length 2 of the next trip 450-2 . . . a length n of a next trip and a confidence level Pn corresponding to the length n of the next trip 450-n) of each of the one or more next trips based on the navigation information 410, the current charging scenario 420, the target historical information 430, the historical trip information 440, and the current driving scenario 520.

The driving scenario prediction layer refers to a model for determining a current driving scenario. In some embodiments, the driving scenario prediction layer may be a machine learning model, such as a CNN model, or the like.

In some embodiments, an input of the driving scenario prediction layer may include historical trip information and navigation information, and an output of the driving scenario prediction layer may include the current driving scenario.

The current driving scenario refers to a current driving scenario of a vehicle to be charged. For example, the current driving scenario may include, but is not limited to, an online hailing scenario, a commuting scenario, a short distance outing scenario (e.g., within the city, or from the city to the outskirts of the city), a long distance outing scenario (e.g., cross-city traveling), etc.

In some embodiments, the driving scenario prediction layer may be obtained by training an initial driving scenario prediction layer based on a large number of third training samples with third labels. The third training samples for training the driving scenario prediction layer may include sample historical trip information and sample navigation information of a sample vehicle. The third labels may include actual current driving scenarios corresponding to the third training samples. The sample navigation information refers to navigation information of the sample vehicle at first time, the sample historical trip information refers to trip information of the sample vehicle at history times prior to the first time, and the actual current driving scenario refers to an actual driving scenario corresponding to the sample vehicle at the the first time.

In some embodiments, the first processing module may determine the third labels by determining the current driving scenario of the sample vehicle in various ways based on information of the third training samples. Merely by way of example, the first processing module may determine, based on a mode of obtaining a manual input, the current driving scenario corresponding to the sample vehicle of the third training samples to serve as the third label corresponding to the third training samples.

In some embodiments, the first processing module may determine, based on the sample historical trip information and the sample navigation information of the sample vehicle in the third training samples, the current driving scenario as the third label through a preset rule.

In some embodiments, the preset rule may be that if trips of the sample vehicle within a latest time period are mainly in a certain region of the city, there is no obvious similarity among start points of the trips and among end points of the trips, and latest navigation information of the sample vehicle is not similar to the historical trip information, then the third labels may be determined as the online hailing scenario.

In some embodiments, the preset rule may also be that if a trip of the sample vehicle reaching a current charging position is highly similar to the sample historical trip information in terms of time period, start point, and end point, for example, the start point and the end point of the sample vehicle within the same time period of the day are the same, then the third labels may be determined as the commuting scenario.

In some embodiments, a training process of the driving scenario prediction layer may be similar to a training process of the first prediction model and may be found in the related descriptions above, which is not repeated here.

The trip prediction layer refers to a model for determining the length of the next trip and the confidence level corresponding to length of the next trip. In some embodiments, the trip prediction layer may be a machine learning model, such as the CNN model, or the like.

In some embodiments, an input of the trip prediction layer may include the navigation information, the current charging scenario, the target historical information, the historical trip information, and the current driving scenario, and an output of the trip prediction layer may include the lengths of the one or more next trips and the confidence level corresponding to the length of each of the one or more next trips.

In some embodiments, the trip prediction layer may be obtained by training an initial trip prediction layer based on a large number of fourth training samples with fourth labels. The fourth training samples of the trip prediction layer may include sample navigation information, a sample current charging scenario, sample target historical information, sample historical trip information, and a sample current driving scenario of a sample vehicle.

The fourth labels may include actual lengths of the one or more next trips corresponding to the fourth training samples and the confidence level corresponding to the length of each of the one or more next trips. The sample navigation information refers to navigation information of the sample vehicle at second time. The sample current charging scenario refers to a current charging scenario of the sample vehicle at the second time. The sample target historical information refers to target historical information of the sample vehicle at historical time before the second time. The sample historical trip information refers to trip information of the sample vehicle at the historical time before the second time. The sample current driving scenario refers to a current driving scenario of the sample vehicle at the second time. The actual lengths of the one or more next trips and the confidence level corresponding to the length of each of the one or more next trips refer to actual lengths of the one or more next trips and a confidence level corresponding to the length of each of the one or more next trips of the sample vehicle at the second time.

In some embodiments, a training process of the trip prediction layer may be similar to the training process of the first prediction model and may be found in the related descriptions above, which is not repeated here.

In some embodiments, the training process of the first prediction model may further include determining different training sample sets and labels corresponding to training samples of each of the different training sample sets based on the current charging scenario; and alternately training an initial prediction model based on the different training sample sets according to sizes of the different training sample sets to obtain a trained first prediction model. The different training sample sets may have different learning rates during the training process. Each of the learning rates may be determined based on a trip reliability of each of the different training sample sets and a proportion of the training samples.

The different training sample sets refer to a collection of data with different features during the training process. In some embodiments, one training sample set may correspond to one charging scenario. For example, a training sample set A may include a plurality of samples with a charging scenario A, and the navigation information, the target historical information, and the historical trip information which are different.

The manner of determining the labels corresponding to the training samples may be similar to a manner of determining the first prediction model and may be found in the related descriptions above, which is not repeated here.

The size of each of the different training sample sets refers to an amount of data or a count of samples in the training sample set. In some embodiments, the different training sample data sets may determine the sizes corresponding to the different training sample data sets by counting the count of samples included in the different training sample data sets. For example, the size of each of the different training sample sets may be categorized as a large size, a moderate size, and a small size according to a threshold. The threshold for the categorization may be set by a technician based on experience or set by the system based on the default.

Alternate training refers to a manner of training the first prediction model using the training sample sets of different sizes. In some embodiments, alternate training is the training of a model through a plurality of different training phases, each using a specific size of the training sample sets. For example, the different training sample sets may be ordered according to the sizes corresponding to the different training sample sets and used sequentially for training the initial first prediction model, thereby enabling alternation between the training sample sets of different sizes. Merely by way of example, a relatively large size of training set may be used for training, then a moderate size of training set may be used for training, and finally a relatively small size of training set may be used for training, and so forth, to alternately update the parameters of the initial first prediction model until a termination condition is met or a preset count of training is reached.

The learning rate refers to an adjustment amplitude of the parameters of the initial first prediction model in each iteration, i.e., a rate at which the initial first prediction model is updated in a gradient direction in a parameter space. In some embodiments, the lower the learning rate, and the slower the rate of change of the loss function, the easier it is for the initial first prediction model to overfit.

Each iteration refers to a process of updating the parameters of the initial first prediction model once during the training process. The gradient direction refers to a direction in which a gradient (i.e., a slope of the loss function) of the loss function with respect to the parameters of the initial first prediction model points.

In some embodiments, the learning rate may be determined in the following manner. First, an initial learning rate may be determined based on a proportion of training samples. An exemplary relationship may be that the larger the proportion of training samples, the lower the initial learning rate, with a minimum initial learning rate not being lower than a preset range. The preset range may be set by a technician based on experience or set by the system based on default. In addition, an adjustment step and an adjustment direction of the learning rate may be determined based on the trip reliability.

The adjustment step of the learning rate refers to an amplitude or a step of adjustment of the learning rate in each iteration. In some embodiments, the higher the trip reliability, the longer the adjustment step of the learning rate.

In some embodiments, the adjustment step of the learning rate may also be manually adjusted or updated during the training process based on an actual training condition.

The adjustment direction of the learning rate refers to an operation of increasing or decreasing the learning rate during the adjustment process. In some embodiments, the adjustment direction of the learning rate may be a gradual decrease in the learning rate.

The proportion of the training samples in the different training sample sets refers to a ratio of a count of training samples included in a current training sample set to a total count of training samples include in all the training sample sets. For example, if there are a total of 1000 training samples classified into 4 training sample sets based on charging scenarios. If a charging scenario A corresponds to 300 training samples, the count of the training samples in the training sample set A may be 300, i.e., the proportion of the training samples in the training sample set A may be 30%.

The trip reliability refers to a degree of consistency between the labels corresponding to the same or similar training samples in the different training sample sets. During the training process, if the labels (i.e., the lengths of the one or more next trips) corresponding to a plurality of similar training samples in the same training sample set are consistent or mostly consistent, the trip reliability of the training sample set may be relatively high. In contrast, if the labels corresponding to the plurality of similar training samples are inconsistent, i.e., the lengths of the one or more next trips corresponding to the same training samples are quite different, the training effect may be poor.

In some embodiments, the trip reliability may be determined as follows. First, the plurality of similar training samples may be determined under the same training sample set, and a variance of a label value (i.e., the length of the next trip) of each of the plurality of similar training samples may be calculated. The obtained plurality of variances may be subjected to maximum-minimum normalization, such that each of the plurality of variances may be normalized to be within a range of [0,1]. More descriptions regarding the normalization process may be found in FIG. 2 and related descriptions thereof. The normalized variances are then subjected to weighted averaging to obtain an overall label variance. Finally, the trip reliability may be calculated as 1 minus the overall label variance, i.e. the smaller the overall label variance, the higher the trip reliability. During the weighted averaging of the plurality of normalized variances, a weight of each variance may be the proportion of the count of training samples of the similar training sample set corresponding to the variance to the total count of training samples in the training sample set.

Each set of the plurality of similar training samples refer to a collection of samples with the same or similar features in the same training sample set. For example, the features may include, but are not limited to, the navigation information, the historical charging information, the historical trip information, etc. In some embodiments, the first processing module may group the different training sample sets using a clustering algorithm. For example, clustering algorithm may include, but is not limited to, k-means clustering, hierarchical clustering, or the like.

In some embodiments of the present disclosure, the different training sample sets and the labels may be determined by different charging scenarios, which optimizes the training of the first prediction model. The problem of poor training effect caused by the inconsistent labels of the plurality of similar training samples in the different training sample sets can be effectively overcome. By determining the learning rate based on the trip reliability and the proportion of the training samples of the different training sample sets, the training step of the model can be adjusted more effectively to make the training process more stable and efficient, thereby avoiding overfitting of the first prediction model.

In some embodiments of the present disclosure, the first processing module may accurately identify the current traveling scene through the driving scenario prediction layer, and the first processing module may predict the length of the next trip and the confidence level corresponding to each predicted length through the trip prediction layer based on various factors such as the navigation information, the current charging scenario, etc. The prediction accuracy can be improved, helping the user better plan the charging requirement, improving the charging efficiency, and reducing the inconvenience caused by undercharging or overcharging.

The basic concept has been described above. Obviously, for those skilled in the art, the above detailed disclosure is only an example, and does not constitute a limitation to the present disclosure. Although not expressly stated here, those skilled in the art may make various modifications, improvements and corrections to the present disclosure. Such modifications, improvements and corrections are suggested in this disclosure, so such modifications, improvements and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This method of disclosure does not, however, imply that the subject matter of the disclosure requires more features than are recited in the claims. Rather, claimed subject matter may lie in less than all features of a single foregoing disclosed embodiment.

In some embodiments, counts describing the quantity of components and attributes are used. It should be understood that such counts used in the description of the embodiments use the modifiers “about”, “approximately” or “substantially” in some examples. Unless otherwise stated, “about”, “approximately” or “substantially” indicates that the stated figure allows for a variation of ±20%. Accordingly, in some embodiments, the numerical parameters used in the disclosure and claims are approximations that can vary depending upon the desired characteristics of individual embodiments. In some embodiments, numerical parameters should consider the specified significant digits and adopt the general digit retention method. Although the numerical ranges and parameters used in some embodiments of the present disclosure to confirm the breadth of the range are approximations, in specific embodiments, such numerical values are set as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A charging optimization system for a new energy vehicle, comprising: an acquisition module, an interaction module, a first processing module, a second processing module, a control module, and a storage module, wherein:
the acquisition module is configured to obtain a user charging requirement, charging price information, and a battery load feature;
the first processing module is configured to determine, based on the user charging requirement and the charging price information, one or more candidate parameters, the one or more candidate parameters including a candidate charging parameter and an estimated charging cost for the candidate charging parameter;
the interaction module is configured to send the one or more candidate parameters to a user and obtain a target charging parameter returned by the user;
the second processing module is configured to determine, based on the battery load feature and the target charging parameter, an optimized charging parameter, the optimized charging parameter including at least one of charging voltages, charging currents, and charging durations in a plurality of phases;
the control module is configured to:
generate, based on the optimized charging parameter, an optimized charging instruction and send the optimized charging instruction to a battery management system to cause the battery management system to charge a battery based on the optimized charging instruction;
in response to determining that the battery management system completes charging, generate current charging information and a storage update instruction and send the current charging information and the storage update instruction to the storage module; and
control the interaction module to send a reminder to the user; wherein:
the storage module stores historical charging information and storage information of the historical charging information, and the storage information includes a count of calls for the historical charging information and a storage duration; and
the storage module is configured to:
store, based on the storage update instruction, the current charging information and the storage information of the current charging information; and
delete historical charging information of which the storage information satisfies a preset deletion condition, the preset deletion condition including that the storage duration is greater than a second preset value and a count of calls within a preset period for the historical charging information is less than a first preset value.

2. The charging optimization system of claim 1, wherein the acquisition module is further configured to: call target historical information and obtain current time information and current position information of a vehicle to be charged, the target historical information being historical charging information of which the storage duration does not exceed a preset duration;
the storage module is further configured to: update a count of calls for the target historical information;
the first processing module is further configured to:
determine, based on the target historical information, a user charging habit;
determine, based on the user charging habit, the current time information, and the current position information, an available charging duration; and
determine, based on the available charging duration, the charging price information, and the user charging requirement, the one or more candidate parameters.

3. The charging optimization system of claim 2, wherein the first processing module is further configured to:
determine, based on the current position information, a current charging scenario; and
determine, based on the user charging habit, the current time information, and the current charging scenario, the available charging duration.

4. The charging optimization system of claim 2, wherein the acquisition module is further configured to: obtain navigation information, a current power level, and historical trip information of the vehicle to be charged; and
the first processing module is further configured to:
determine, based on the navigation information, a current charging scenario, the target historical information, and the historical trip information, a length of a next trip; and
determine, based on the length of the next trip and the current power level, the user charging requirement.

5. The charging optimization system of claim 4, wherein the first processing module is further configured to:
determine, based on the navigation information, the current charging scenario, the target historical information, and the historical trip information, lengths of one or more next trips and a confidence level corresponding to a length of each of the one or more next trips through a first prediction model, the first prediction model being a machine learning model.

6. The charging optimization system of claim 5, wherein the first processing module is further configured to:
determine, based on a weighted value of the lengths of the one or more next trips and the current power level, the user charging requirement, the weighted value of the lengths of the one or more next trips being related to the confidence level corresponding to the length of each of the one or more next trips.

7. The charging optimization system of claim 5, wherein a weighted value of the lengths of the one or more next trips is related to the available charging duration.

8. The charging optimization system of claim 5, wherein the first prediction model includes a driving scenario prediction layer and a trip prediction layer;
the driving scenario prediction layer is configured to determine, based on the historical trip information and the navigation information, a current driving scenario; and
the trip prediction layer is configured to determine, based on the navigation information, the current charging scenario, the target historical information, the historical trip information, and the current driving scenario, the lengths of the one or more next trips and the confidence level corresponding to the length of each of the one or more next trips.

9. The charging optimization system of claim 5, wherein a training process of the first prediction model includes:
determining, based on the current charging scenario, different training sample sets and labels corresponding to training samples in each of the different training sample sets; and
alternately training an initial prediction model based on the different training sample sets according to sizes of the different training sample sets to obtain a trained first prediction model, wherein the different training sample sets have different learning rates during the training process, and each of the learning rates is determined based on a trip reliability of each of the different training sample sets and a proportion of the training samples.

10. The charging optimization system of claim 1, wherein the second processing module is further configured to:
determine, based on the battery load feature and the target charging parameter, a plurality of candidate optimization parameters; and
determine, based on the plurality of candidate optimization parameters, the optimized charging parameter.

11. The charging optimization system of claim 10, wherein the second processing module is further configured to:
determine, based on a second prediction model, an evaluation parameter of each of the plurality of candidate optimization parameters, the evaluation parameter including a charging loss and a charging gain; and
determine, based on the evaluation parameter of each of the plurality of candidate optimization parameters, the optimized charging parameter.

12. A charging optimization method for a new energy vehicle, implemented based on a charging optimization system for a new energy vehicle, comprising:
obtaining a user charging requirement, charging price information, and a battery load feature;
determining, based on the user charging requirement and the charging price information, one or more candidate parameters, the one or more candidate parameters including a candidate charging parameter and an estimated charging cost for the candidate charging parameter;
sending the one or more candidate parameters to a user and obtaining a target charging parameter returned by the user;
determining, based on the battery load feature and the target charging parameter, an optimized charging parameter, the optimized charging parameter including at least one of charging voltages, charging currents, and charging durations in a plurality of phases;
generating, based on the optimized charging parameter, an optimized charging instruction and sending the optimized charging instruction to a battery management system to cause the battery management system to charge a battery based on the optimized charging instruction;
in response to determining that the battery management system completes charging, generating current charging information and storing the current charging information as historical charging information, and storing storage information of the current charging information, the storage information including a count of calls for the historical charging information and a storage duration;
sending a reminder to the user; and
deleting historical charging information of which the storage information satisfies a preset deletion condition, the preset deletion condition including that the storage duration is greater than a second preset value and a count of calls within a preset period for the historical charging information is less than a first preset value.

13. The charging optimization method of claim 12, wherein the determining, based on the user charging requirement and the charging price information, candidate parameters includes:
calling target historical information and obtaining current time information and current position information of a vehicle to be charged, the target historical information being historical charging information of which the storage duration does not exceed a preset duration;
updating a count of calls for the target historical information;
determining, based on the target historical information, a user charging habit;
determining, based on the user charging habit, the current time information, and the current position information, an available charging duration; and
determining, based on the available charging duration, the charging price information, and the user charging requirement, the one or more candidate parameters.

14. The charging optimization method of claim 13, wherein the determining, based on the user charging habit, the current time information, and the current position information, an available charging duration includes:
determining, based on the current position information, a current charging scenario; and
determining, based on the user charging habit, the current time information, and the current charging scenario, the available charging duration.

15. The charging optimization method of claim 13, wherein the obtaining the user charging requirement includes:
obtaining navigation information, a current power level, and historical trip information of the vehicle to be charged;
determining, based on the navigation information, a current charging scenario, the target historical information, and the historical trip information, a length of a next trip; and
determining, based on the length of the next trip and the current power level, the user charging requirement.

16. The charging optimization method of claim 15, wherein the determining, based on the navigation information, the current charging scenario, the target historical information, and the historical trip information, a length of a next trip includes:
determining, based on the navigation information, the current charging scenario, the target historical information, and the historical trip information, lengths of one or more next trips and a confidence level corresponding to a length of each of the one or more next trips through a first prediction model, the first prediction model being a machine learning model.

17. The charging optimization method of claim 15, wherein the determining, based on the length of the next trip and the current power level, the user charging requirement includes:
determining, based on a weighted value of the lengths of the one or more next trips and the current power level, the user charging requirement, the weighted value of the lengths of the one or more next trips being related to the confidence level corresponding to the length of each of the one or more next trips.

18. The charging optimization method of claim 12, wherein the determining, based on the battery load feature and the target charging parameter, an optimized charging parameter includes:
determining, based on the battery load feature and the target charging parameter, a plurality of candidate optimization parameters; and
determining, based on the plurality of candidate optimization parameters, the optimized charging parameter.

19. The charging optimization method of claim 18, wherein the determining, based on the plurality of candidate optimization parameters, the optimized charging parameter includes:
determining, based on a second prediction model, an evaluation parameter of each of the plurality of candidate optimization parameters, the evaluation parameter including a charging loss and a charging gain; and
determining, based on the evaluation parameter of each of the plurality of candidate optimization parameters, the optimized charging parameter.

20. A non-transitory computer-readable storage medium comprising computer instructions that, when read by a computer, direct the computer to implement the charging optimization method for the new energy vehicle of claim 12.
